(19) United States
(12) Patent Application Publication
(10) Pub. No.: US 2004/0133645 A1
(43) Pub. Date: Jul. 8, 2004

(54) Systems and methods for capturing and archiving email

(76) Inventors: Joseph A. Massanelli, Dallas, GA (US); John Townsley Kidd, Atlanta, GA (US)

Correspondence Address: William R. Silverio, SUTHERLAND ASBILL & BRENNAN LLP, 999 Peachtree Street, NE, Atlanta, GA, 30309-3996, US

(21) Appl. No.: 10/610,267

(22) Filed: Jun. 30, 2003

Related U.S. Application Data
(60) Provisional application No. 60/392,371, filed on Jun. 28, 2002.
(60) Provisional application No. 60/462,294, filed on Apr. 11, 2003.

(51) Int. Cl. G06F 15/16; G06F 17/30; G06F 7/00

(52) U.S. Cl. 709/206; 707/10

(57) ABSTRACT

Systems and methods effect audit resource planning and data collection and storage by selectively capturing and storing for future reference all relevant electronic correspondence, including emails and attachments, transmitted between a company and a company's vendors or business partners. Systems and methods utilize operator-defined selection criteria to determine whether electronic correspondence is pertinent. Selection criteria is applied in either real-time to incoming and outgoing emails, or to past emails. Emails, and scanned paper documents, identified by the selection criteria as pertinent are stored in a searchable and retrievable format to enable an auditor or post-audit provider to access the necessary documentation.

### RELATED APPLICATION DATA

The present invention claims priority from U.S. Provisional Patent Application No. 60/392,371, titled “Systems and Methods for Planning an Audit and Archiving Electronic Mail for Use in Same,” filed on Jun. 28, 2002, and U.S. Provisional Patent Application No. 60/462,294, titled “Systems and Methods for Email Capture and Archiving,” filed on May 8, 2003. The contents of the above-identified provisional applications are incorporated herein by reference as if set forth fully herein.

### FIELD OF THE INVENTION

The present invention generally relates to recovery audits, and more specifically, to systems and methods for automatically capturing and archiving electronic correspondence, such as emails, to support recovery audits.

### BACKGROUND OF THE INVENTION

Companies lose millions of dollars annually because of unpaid invoices, double payments, discounts and allowances not received, and overpayments. While some of these mistakes are rectified by annual audits performed by a company's accounting firm, such audits are generally not thorough enough to identify all the recoverable losses due to the typically high number of business transactions and associated material that must be reviewed. As a consequence, companies such as PRG-Schultz, the assignee of the present application, provide recovery audit services directed at identifying company overpayments and collecting the monies due from company clients for underpayments. The successful execution of a recovery audit is dependent on a number of factors, including the audit planning process and the collection of relevant documentation.

The planning of an audit has historically been done manually, with little to no leverage of previous audit plans or consistency between plans. This results in several problems, such as lack of consistency in audit executions from year to year, incomplete plans, and a failure to build on best practices across all audits. Thus, a tool is needed within the audit-recovery industry which provides a complete and consistent plan for each audit, built on the successes of prior audits and the use of best-in-class audit procedures.

Until recently, all correspondence between a client and a its vendors has had a paper trail (e.g., either through a paper letter or facsimile) that could be referenced when determining compliance with particular negotiated agreements or amendments. If and when a dispute arose, there was almost always a paper document to which to refer for clarification. Today however, more correspondence between a client and its vendors is conducted via email. For instance, where buy/sell transactions were once done almost exclusively on paper, today's business environment often results in these transactions being consummated via electronic documents. While some merchandisers print and store paper copies of their emails with vendors, many do not and thus lose the necessary documentation to ensure compliance with the agreements and amendments they negotiated.

When these electronic documents are not part of a larger enterprise software solution (i.e., electronic invoicing systems), accessing this information can be difficult. Included in these electronic documents are price commitments, notifications of price changes, and vendor agreements with special discounts and allowances. All of these items may be necessary documentation to execute an effective audit. Despite the importance of such documents and communications, companies typically don't have an archiving system for storing such electronic documents, or if they do, it is an enterprise-wide solution that requires the storage of enormous amounts of data (i.e., all emails.) Privacy issues are also a hindrance to companies that wish to archive all of an employee's emails. In fact, many companies have internal policies preventing the dissemination of personal emails to third parties, such as the auditors. Without the transactional data that is communicated in today's business environment via email, audits may miss a significant number of potential claims, which may result in the unsuccessful recovery of millions of dollars in claims.

Thus, an unsatisfied need exists in the industry for an efficient means of identifying and storing electronic communications, primarily emails, to permit a client's post-audit provider to access the necessary documentation to ensure that a client's business partners and vendors have complied with all negotiated agreements and amendments.

### SUMMARY OF THE INVENTION

Systems and methods of the present invention effect audit resource planning and data collection and storage. More specifically, the present invention provides systems and methods that enables all relevant electronic correspondence (including emails and attachments) between a company and a company's vendors to be selectively captured and stored for future reference to ensure vendor compliance with all negotiated agreements and amendments the vendor entered into with a company. The present invention therefore enables a client's post-audit provider to access the necessary documentation to ensure that a client's vendors have complied with all negotiated agreements and amendments.

It will be appreciated that increasing amounts of correspondence between a client and its vendors have started to shift from paper or fax to email. As such, important information concerning agreements and amendments may become lost. Even with stringent procedures and controls in place for information to be printed and filed or keyed into corporate systems, there will be some loss of potentially important data. And once a client's systems purge email, that data, and the agreements that it supports, could be lost forever. With the systems, methods and computer program products of the present invention, all relevant email concerning negotiated deals, agreements, and amendments are reviewed, captured and archived for possible future reference. Thus, a client will no longer need to worry if its procedures and controls are being followed. Key features and benefits of the present invention include the ability to capture emails based on customized selection criteria, such that the present invention only captures emails relevant to maintaining a historical account of business transactions that may be reviewed in a recovery audits.

Systems and methods of the present invention can also index emails, and email attachments, by vendor or buyer to enable quick and efficient location of correspondence. Furthermore, systems and methods of the present invention can store emails with additional scanned documents in a central location, such that all documents relating to a business transaction are maintained together and readily accessible. Additionally, the present invention ensures that all emails and attachments are securely archived. As such, systems and methods of the present invention are suited for any accounts payable or merchandising department manager who wants the assurance that the company critical purchasing and procurement-related emails are being captured, indexed, and archived for future reference.

### BRIEF DESCRIPTION OF THE DRAWINGS

Having thus described the invention in general terms, reference will now be made to the accompanying drawings, which are not necessarily drawn to scale, and wherein:

FIG. 1 shows a block diagram illustrating an email capture and archiving system according to one embodiment of the present invention.

FIG. 2 shows a block diagram flow chart illustrating a process implemented by the email capture and archiving system of FIG. 1, according to one embodiment of the present invention.

FIG. 3 shows a block diagram illustrating an email capture and archiving system according to another embodiment of the present invention.

FIG. 4 shows a block diagram flow chart illustrating a process implemented by the email capture and archiving system of FIG. 3, according to one embodiment of the present invention.

### DETAILED DESCRIPTION OF THE INVENTION

The present inventions now will be described more fully hereinafter with reference to the accompanying attachments, in which some, but not all embodiments of the invention are described. Indeed, these inventions may be embodied in many different forms and should not be construed as limited to the embodiments set forth herein; rather, these embodiments are provided so that this disclosure will satisfy applicable legal requirements.

It will be appreciated that the systems and methods of the present invention are described below with reference to block diagrams and flowchart illustrations. It should be understood that blocks of the block diagrams and flowchart illustrations, and combinations of blocks in the block diagrams and flowchart illustrations, respectively, may be implemented by computer program instructions. These computer program instructions may be loaded onto a general purpose computer, special purpose computer, or other programmable data processing apparatus to produce a mechanism, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

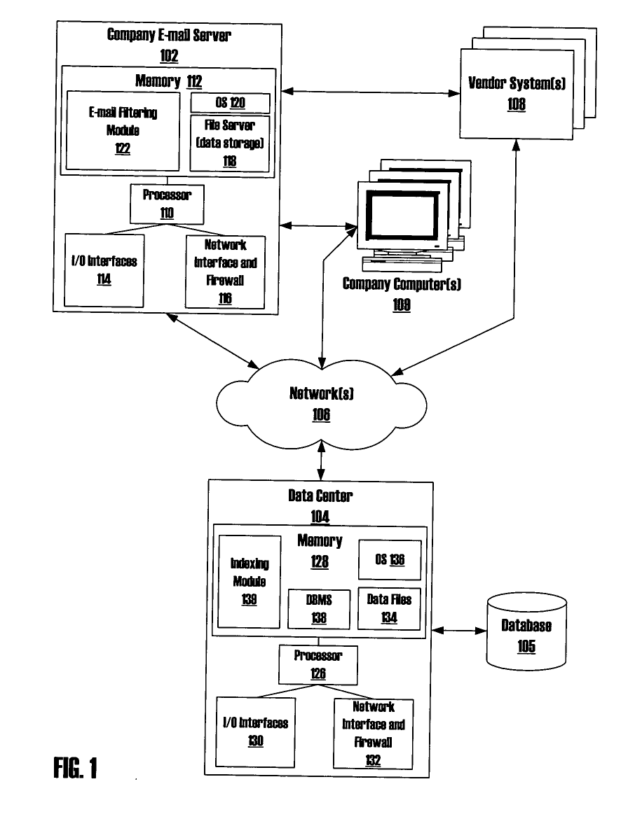

FIG. 1 shows a block diagram illustrating an exemplary operating environment for implementation of certain embodiments of the present invention. The exemplary operating environment encompasses a company email server 102 and a data center 104, which are each configured for accessing and reading associated computer-readable media having stored thereon data and/or computer-executable instructions for implementing the various methods of the present invention. As described in detail below, the data center 104 backs-up the company email server 102 by storing relevant communications necessary for audits, including recovery audits. It should be appreciated that though the data center 104 is illustrated in FIG. 1 as separate from the company email server 102, the data center 104 may be local to the company email server 102. Alternatively, the data center 104 may be remote from the company email server 102 and in secure communication with the company email server 102 via a WAN connection such as the Internet.

As shown in FIG. 1, the operating environment also includes one or more company computers 109 and one or more vendor systems 108, which are in electrical communication with the company email server 102. The one or more company computers 109 and one or more vendor systems 108 are in electrical communication with the company email server 102 either directly or via one or more networks 106, which may include one or more Local Area Networks (LANs) and/or one or more Wide Area Networks (WANs). For instance, according to one aspect of the present invention, the one or more company computers 109 may exist on the same LAN with the company email server 102, while the vendor systems 108 communicate with the company email server 102 via the Internet.

As shown in FIG. 1, the company email server 102 is in communication with the data center 104 via one or more networks 106. The company email server 102 may be configured to receive and transmit electronic communications (where electronic communications include email and associated attachments) among the various devices with which it is in communication. The company email server 102 stores and/or transmits electronic communications to the one or more company computers 109 and permits the company computers to transmit electronic communications to computers, such as the vendor systems 108, in electrical communication with the company computers 109 via the one or more networks 106.

According to one aspect of the invention, the company email server 102 may include a mail transfer agent (MTA), which is a program responsible for receiving, routing, and delivering email messages for use on Windows or MAC operating system, a Unix server, or the like. According to another aspect of the present invention, the company email server 102 simply passes email directly to the company computers 109, and the company computers 109 manage the emails. According to yet another aspect of the present invention, the company email server 102 may run an IMAP (Internet Message Access Protocol) service for electronic communications, such that email sent to and from the company computers 109 is stored locally on the email file server 118. In such an embodiment, it is transparent to users that the emails reside on the company email server 102 rather than their company computer 109 because each company computer 109 accesses individual emails (and attachments thereto) remotely.

The company email server 102 may be any processor-driven device, such as a personal computer, laptop computer, or the like. In addition to a processor 110, the company email server 102 may further include a memory 112, input/output (“I/O”) interface(s) 114 and a network interface 116. The memory 112 may store data files 118 and various program modules, such as an operating system (“OS”) 120. The OS 120 operates in conjunction with the processor 110 to execute the email server functions implemented by the company email server 102. I/O interface(s) 114 facilitate communication between the processor 110 and various I/O devices, such as a keyboard, mouse, printer, microphone, speaker, monitor, etc. The network interface and firewall 116 may take any of a number of forms, such as a network interface card, a modem, etc, and permits the company email server 102 to securely communicate with other computers external to the company email server 102. These and other components of the company email server 102 will be apparent to those of ordinary skill in the art and are therefore not discussed in more detail herein.

As shown in FIG. 1, the company email server 102 further includes an email filtering module 122. The email filtering module 122 may comprise computer-executable instructions for performing archiving, filtering, selection and extraction of email stored in the company email server 102. For instance, where the company email server 102 runs an IMAP service, the email filtering module 122 enables one or more operators to filter email stored within the file server 118 based on one or more predefined selection criteria. Alternatively, where email is stored on individual company computers 109 rather than on the file server 118, the email filtering module 122 is operable to examine and filter email forwarded to the company computers 109 based on one or more predefined selection criteria.

According to the embodiment illustrated in FIG. 1, emails may be filtered in real-time or near real-time using the selection criteria. Therefore, immediately upon receipt by the company email server 102 the predefined selection criteria is applied against emails and email attachments. This occurs for both incoming and outgoing email and their respective attachments. Email and attachments satisfying the selection criteria are copied and forwarded to the data center 104 where they are stored. Because all relevant email concerning a company's negotiated deals, agreements, and amendments are reviewed, copied, and archived in the data center 104, a company does not need to concern itself with maintaining emails to preserve a historical account of business transactions.

It will be appreciated by those of ordinary skill in the art that access to company transaction data is imperative to implementing a recovery audit process. Therefore, according to one aspect of the present invention, the selection criteria are developed by the company and an audit or post-audit team. This process seeks to identify only those emails and documents pertinent to an audit analysis. Without access to the relevant data, information relevant to the audit process could otherwise be missed.

The selection criteria can include select words or phrases, including internet domains, vendor names or IDs, account or sub-account data, individual user names (e.g., email recipients or authors), dates or date ranges, facilities or store locations or store IDs, particular products or reference numbers, or like criteria or combination thereof. Furthermore, emails matching certain selection criteria can be excluded from selection, such as an email sent within the client's internal email system that may have certain key words or phrases but never sent outside the company. The selection criteria to identify these emails may be configured to search both an email's heading, content and attachments such that any content including the selection criteria may be identified by the email filtering module 122. To effect the input of such selection criteria, the email filtering module 122 may implement one or more user-friendly graphical user interfaces, which operate to receive the selection criteria terms via the I/O interfaces 114. According to one aspect of the present invention, the email filtering module 122 may also utilize Optical Character Recognition (OCR) to review the content of attachments to ensure that all relevant material is identified.

As noted above, the purpose of the data center 104 is to collect and organize electronic communications transmitted between and among the company computers 109 and vendor systems 108 to permit the company's audit or post-audit providers to access necessary documentation to ensure that the company's business partners (e.g., vendors running the vendor systems 108) have complied with all negotiated agreements. Electronic communications include any communications, such as email and attachments, typically provided by a company, vendor or individual or company transacting with the company. The content and/or format of an electronic communication forwarded to the data center 104 may vary depending on which format, standard or protocol is used. And in certain embodiments the data center 104 may serve as a clearinghouse for storing electronic communications from multiple company email servers. Additionally, approval or rejection messages may be returned to the company email server 102 from the data center 104 to confirm receipt of archiving electronic communications.

As illustrated in FIG. 1, the data center 104 may be any processor-driven device that is configured for receiving and storing electronic communications that may be used to effect an audit or post-audit. The data center 104 therefore includes a processor 126, a memory 128, input/output (“I/O”) interface(s) 130 and a network interface and firewall 132. The memory 128 may store data files 134 and various program modules, such as an operating system (“OS”) 136, a database management system (“DBMS”) 138 and an indexing module 139. The indexing module 139 may comprise computer-executable instructions for performing indexing, importing, retrieval and viewing processes. According to one aspect of the present invention, the indexing module 139 receives electronic communications, including emails and associated attachments, from the email filtering module 122 and indexes the emails and attachments based on vendor name (or other entity name, such as a buyer, transacting business with the company) to which the communication relates. Indexing the electronic documents based on this information enables correspondence to be located quickly and efficiently. The documents may be indexed and stored in a database 105, which may be managed by the DBMS 138.

According to one aspect of the present invention, the indexing module 139 is further operable to permit an operator to search and view the contents stored within the database 105. These documents may contain not only the pertinent emails and attachments identified and forwarded by the email filtering module 122, but also scanned correspondence identified in paper-based files that were not previously memorialized in electronic form. Scanned correspondence may be subjected to OCR to permit them to be searched. According to another aspect of the present invention, scanned correspondence subjected to OCR may be filtered by the email filtering module 122 or indexing module 139 using the same selection criteria used by the email filtering module 122 to identify relevant emails and attachments. Therefore, all relevant documents to a recovery audit may be stored in the same location and easily accessed by a client or auditor.

Because the indexing module permits flexible searching of all documents pertinent to an audit based on one or more keywords, the indexing module 139 provides a single powerful tool to provide auditors all of the information needed to perform an audit. Furthermore, once the emails and attachments are stored, they are preferably simultaneously made available to multiple users via a LAN or WAN (e.g., the Internet) in a searchable form.

As shown in FIG. 1, the database 105 for storing the electronic documents forwarded to the data center 104 from the company email server 102 is illustrated as external or remote from the data center 104. However, it will be appreciated that the database 105 may be located within the data center 104 or integrated within the memory 128 of the data center 104. In addition to pertinent emails and attachments, the database 105 may also store reports and other data relating to the results of the post-auditing processes and any other data used or generated by the data center 104, such as data used in other pre-processing and post-processing methods. Although a single database 105 is referred to herein for simplicity, those skilled in the art will appreciate that multiple physical and/or logical databases may be used to store the above mentioned data. For security, the data center 104 may have a dedicated connection to the database 105. However, the data center 104 may also communicate with the database 105 via the network 106.

It should be appreciated that the data center 104 may include additional program modules (not shown) for performing other post-audit processing methods and for providing clearinghouse services. Those skilled in the art will appreciate that the data center 104 may include alternate and/or additional components, hardware or software. In addition, the data center 104 may be connected to a local or wide area network (not shown) that includes other devices, such as routers, gateways, and the like. Moreover, it should be appreciated that the network 106 may comprise any telecommunication and/or data network, whether public or private, such as a local area network, a wide area network, an intranet, an internet and/or any combination thereof and may be wired and/or wireless. Due to network connectivity, various methodologies as described herein may be practiced in the context of distributed computing environments. And although the exemplary company email server 102 is shown for simplicity as being in communication with the data center 104 via one intervening network 106, it is to be understood that any other network configuration is possible. For example, the company email server 102 may be connected to a company's local or wide area network, which may include other devices, such as gateways and routers, for interfacing with another public or private network 106. Instead of or in addition to a network 106, dedicated communication links may be used to connect the various devices of the present invention.

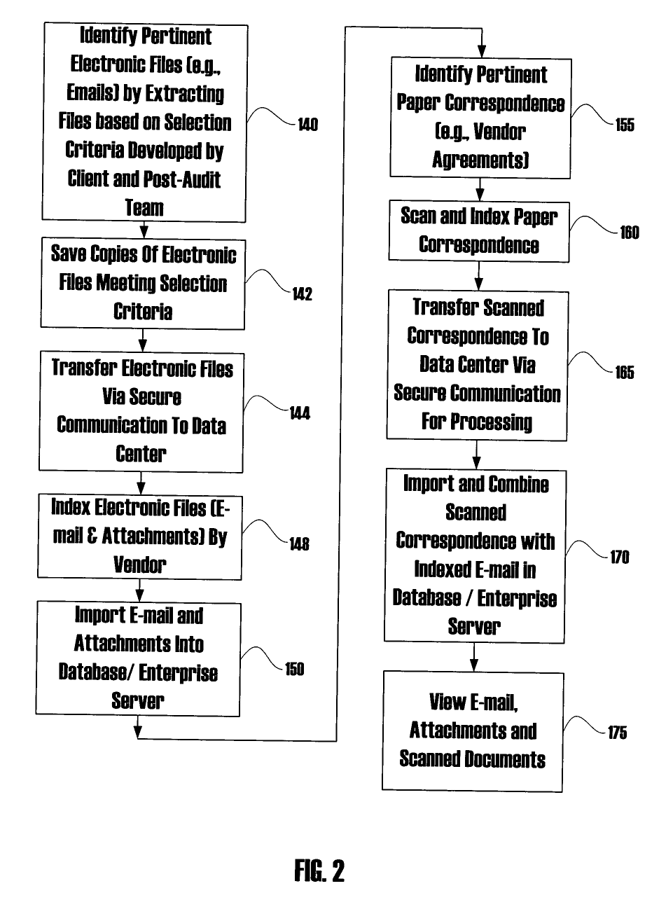

Those skilled in the art will appreciate that the operating environment shown in and described with respect to FIG. 1 is provided by way of example only. Numerous other operating environments, system architectures and device configurations are possible. For example, the invention may in certain embodiments be implemented in a non-networked environment, in which a stand-alone company email server may execute both the email filtering module 122 and indexing module 139. Accordingly, the present invention should not be construed as being limited to any particular operating environment, system architecture or device configuration. The real-time or near real-time email capture and archive implemented by the system of FIG. 1 will next be described with respect to FIG. 2.

FIG. 2 shows a block diagram flow chart illustrating a process implemented by the email capture and archiving system of FIG. 1, according to one embodiment of the present invention. As shown in FIG. 2 the process begins with the identification of pertinent electronic files using selection criteria predefined by the company and/or auditor (block 140). This process is executed using the email filtering module 122, which operates to compare each email transmitted from or received at the company email server 102 with the selection criteria, in real-time or near real-time. This process filters electronic communications that may be pertinent to future audits from non-pertinent files unnecessary for a future audit. According to one aspect of the present invention, the email filtering module 122 may comprise a plug-in program that works with the company email server 102, or an email program (e.g., Microsoft Outlook™) operating therewith, to interrogate the sent and received electronic communications in real-time or near real-time.

As an illustrative example, the email plug-in may be operable to monitor the emails and attachments to and from selected personnel to identify those that match the predefined selection criteria. As another illustrative example, the email plug-in may be operable to monitor the emails and attachments to and from all personnel to identify those that match selection criteria. Using the plug-in or a like component, emails and attachments may be compared against the selection criteria to filter the emails and attachments. These selection criteria can include the inclusion or exclusion of emails and attachments having specified: keywords (e.g., vendor names); combinations of words (phrases); recipients or senders (e.g., email addresses or email domain names, internal or external domain names); combination of keywords and phrases; time stamps; conditional expressions; and other fields that may be used to screen emails and attachments for possible relevance to transactions that the system will memorialize. As noted above, the email filtering module 122 preferably includes one or more graphical user interfaces for defining the selection criteria such that the selection criteria can be viewed and changed or updated relatively easily.

Once the emails and attachments meeting the selection criteria are identified, copies of the selected emails are made (block 142) and transported via a secure communication, such as File Transfer Protocol (FTP) or email, to the data center 104 (block 144). The emails are then imported into the data center 104, which operates as a data management system. According to one aspect of the present invention, the indexing module 139 of the data center 104 indexes emails and attachments based on the vendor or business entity name (block 148), and imports the indexed documents into a database or enterprise server (block 150). According to one aspect of the present invention, the indexed documents are stored in the database 105 managed by the DBMS 138. According to one embodiment of the present invention, the emails and attachments are imported and indexed using a document management system such as ImDex™, which is a document scanning and management package owned by the assignee of the present invention. ImDex™ can facilitate the uploading of pertinent emails and attachments used to support recovery audits to a central data repository and/or a data repository accessible via the Internet. Additionally, ImDex™ provides customized search capabilities of any uploaded documents and includes a variety of search, view and indexing capabilities. ImDex™ can also capture documents by scanning paper, by simple drag and drop techniques or through file imports.

Referring again to FIG. 2, pertinent paper correspondence may also be identified (block 155), scanned (block 160), and transferred to the data center 104 via a secure communication for processing (block 165). Like the emails and attachments, the scanned correspondence is then compared against the selection criteria, indexed, based preferably by vendor name, and stored in an enterprise server (block 170). It will be appreciated that although the steps identified by blocks 155-170 are illustrated as being performed subsequent to the steps identified by blocks 140-150, the steps of blocks 155-170 may also be performed or executed simultaneously with the steps identified by blocks 140-150.

After the emails, attachments and scanned correspondence are stored and indexed by vendor, each is viewable and searchable according to vendor name, date or any other criteria such that the emails, attachments and scanned correspondence are readily accessible by a client or auditor (block 175) via search terms (e.g., vendor name). Because the emails and attachments are archived, filtered and saved, the originals may be deleted from the client system. One advantage to archiving both emails and attachments, and utilizing OCR on the attachments, allows for a full indexed text search to be performed on words and phrases in addition to standard SQL functionality.

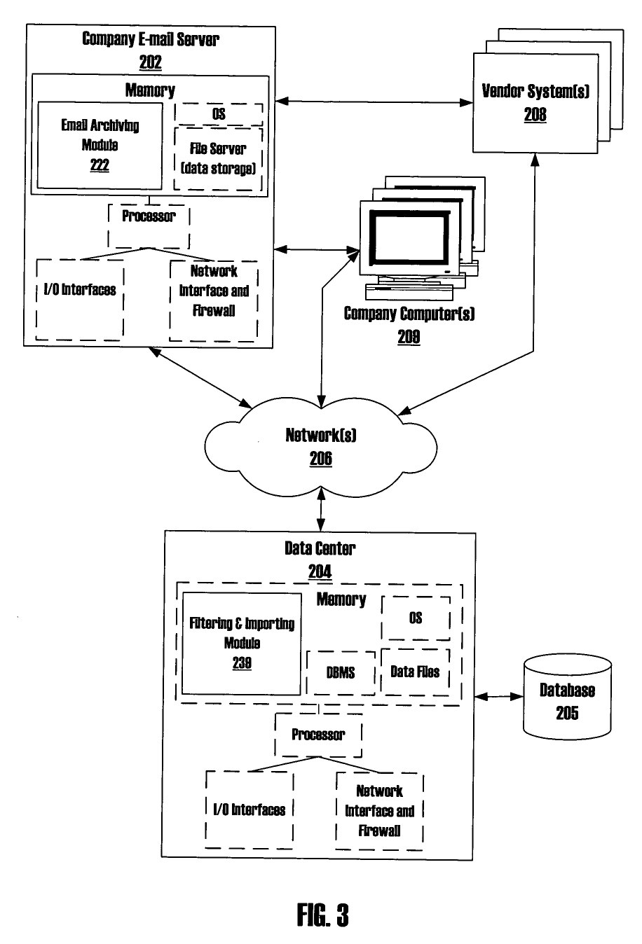

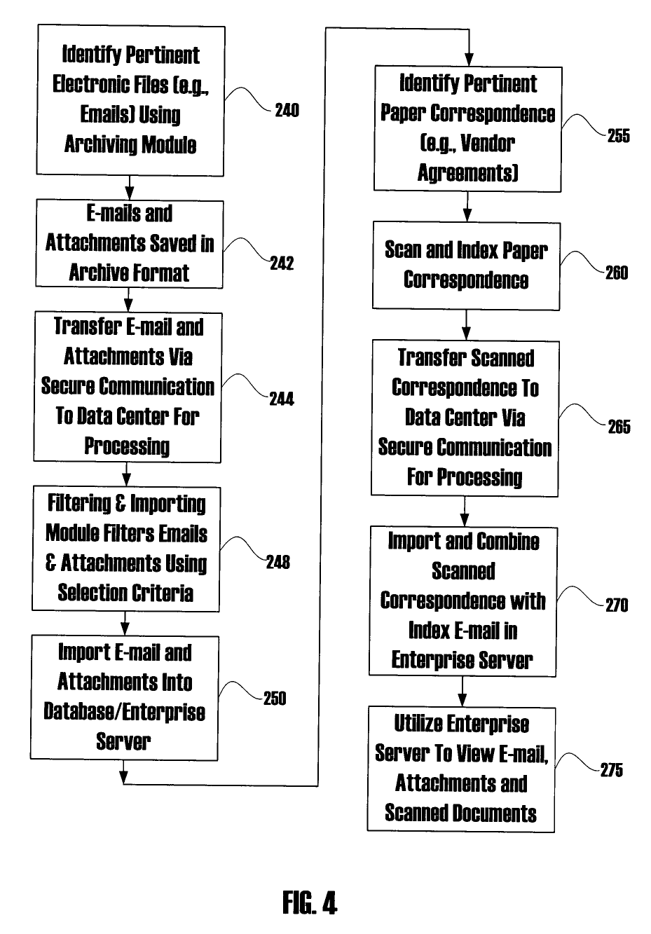

It will be appreciated that the system and methods of FIGS. 1 and 2 disclose a first of two alternative processes for capturing electronic communications according to the present invention. The process described above captures emails in real-time or near-real time. The second and alternative process, considered hereinafter with respect to FIGS. 3 and 4, captures stored emails and attachments at purge time but before the emails are deleted from a system.

FIG. 3 illustrates a block diagram illustrating an exemplary operating environment for implementation of certain embodiments of the present invention. Like the embodiment described with respect to FIG. 1, the exemplary operating environment encompasses a company email server 202 and a data center 204, where the data center 204 backs-up the company email server 202 by storing relevant communications necessary for future audits. Additionally, like the embodiment of FIG. 1, there are one or more company computers 209 and one or more vendor systems 208, which are in electrical communication with the company email server 202. For purposes of brevity, the relationship among the components illustrated in FIG. 3 is similar to the relationship between the like components illustrated in FIG. 1, and therefore the description provided above with respect to FIG. 1 applies equally to FIG. 3. Likewise, the components of FIG. 3 are also similar to the components of FIG. 1, but for the email archiving module 222 in FIG. 3, which replaces the email filtering module 122 of FIG. 1, and the filtering and importing module 239, which replaces the indexing module 139 of FIG. 1. Therefore, but for these two differences, the language describing the system components of FIG. 1 applies equally to the like components of FIG. 3. As such, those identical components are not further considered herein and are illustrated with dashed lines in the block diagram of FIG. 3.

Unlike the first embodiment described with respect to FIGS. 1 and 2, in which emails are captured in real-time or near-real time using a plug-in program, the system shown in FIG. 3 captures stored emails and attachments at purge time but before the emails are deleted from a system. However, essentially the same processes are used in this embodiment to identify pertinent emails, attachments and scanned correspondence.

More particularly, as illustrated in FIG. 3, the company email server 202 includes an email archiving module 222, which may comprise computer-executable instructions for performing archiving of email stored in the email server 202. More specifically, the email archiving module 222 saves emails and their attachments in an archive format, such as PST or MSG, prior to the permanent deletion of the emails and attachments by the company email server 202. This may occur at the end of each business day, at the end of each week, on a monthly basis, or any other regular or irregular term adopted by the company. After the emails and attachments are archived, a backup or copy is created by the email archiving module 222, which transmits the backup or copy to the data center 204. Therefore, unlike the email filtering module 122, the email archiving module 222 does not apply predefined selection criteria to emails and attachments to identify those emails and attachments that may be most pertinent in later audit. Rather, the application of selection criteria is applied by the filtering and importing module 239 of the data center 204 after receipt of the backup or copy.

Therefore, upon receipt by the data center 204 the filtering and importing module 239 applies predefined selection criteria against emails and any attachments. The selection criteria can include select words or phrases, including internet domains, vendor names or IDs, account or sub-account data, individual user names (e.g., email recipients or authors), dates or date ranges, facilities or store locations or store IDs, particular products or reference numbers, or like criteria or combination thereof. Furthermore, emails matching certain selection criteria can be excluded from selection, such as an email sent within the client's internal email system that may have certain key words or phrases but never sent outside the company. The selection criteria to identify these emails may be configured to search both an email's heading, content and attachments such that any content including the selection criteria may be identified by the filtering and importing module 239. According to one aspect of the present invention, the filtering and importing module 239 may also utilize Optical Character Recognition (OCR) to review the content of attachments to ensure that all relevant material is identified.

According to one aspect of the present invention, the filtering and importing module 239 is also operable to apply the predefined selection criteria against scanned correspondence identified in paper-based files that were not previously memorialized in electronic form. Scanned correspondence may be subjected to OCR to permit them to be compared against the selection criteria used by the filtering and importing module 239 to identify relevant emails and attachments. OCR also permits the scanned correspondence to be searched, as explained further below.

Emails and attachments and scanned correspondence satisfying the selection criteria are then indexed by the filtering and importing module 239 using the vendor name (or name of a buyer or other entity transacting with the company). Thereafter, the emails and attachments are imported into a database or enterprise server to permit them to be accessible and searchable later. As with the first embodiment, because all relevant email concerning a company's negotiated deals, agreements, and amendments are identified and archived by the data center 204, a company does not need to concern itself with maintaining emails to preserve a historical account of business transactions.

According to another aspect of the present invention, the filtering and importing module 239 is further operable to permit an operator to search and view the contents stored within the database. These documents may contain not only the pertinent emails and attachments identified and forwarded by the email archiving module 222, but also scanned correspondence identified in paper-based files that were not previously memorialized in electronic form. Therefore, all relevant documents to a recovery audit may be stored in the same location and easily accessed by a client or auditor.

Because the filtering and importing module 239 permits flexible searching of all documents pertinent to an audit based on one or more keywords, the filtering and importing module 239 provides a single powerful tool to provide auditors all of the information needed to perform an audit. Furthermore, once the emails and attachments are stored, they are preferably simultaneously made available to multiple users via a LAN or WAN (e.g., the Internet) in a searchable form.

Those skilled in the art will appreciate that the operating environment shown in and described with respect to FIG. 3 is provided by way of example only. Numerous other operating environments, system architectures and device configurations are possible. For example, the invention may in certain embodiments be implemented in a non-networked environment, in which a stand-alone company email server may execute both the email archiving module 222 and the filtering and importing module 239. Accordingly, the present invention should not be construed as being limited to any particular operating environment, system architecture or device configuration. The batch email and attachment capture implemented by the system illustrated in FIG. 3 will next be described with respect to FIG. 4.

FIG. 4 shows a block diagram flow chart illustrating a process implemented by the email capture and archiving system of FIG. 3, according to one embodiment of the present invention. According to this embodiment of the present invention, emails sent, received and/or deleted by one or more company computer 209 email users are identified and saved (blocks 240, 242) by the email archiving module 222 in an archive format, such as PST, MSG, or the like. Before their deletion from data storage and/or company computers 209, the archived emails and attachments are transmitted to the data center 204 via File Transfer Protocol (FTP), on magnetic media, or on alternative media (e.g., DVD-ROMS or CD-ROMs) for processing (block 244).

Upon receiving the backup emails and alternative media, the data center 204, and more particularly, the filtering and importing module 239, may utilize selection criteria to filter the emails and attachments (block 248). These criteria can include the inclusion or exclusion of emails having the specified selection criteria noted above, and other fields that may be used to screen emails and attachments for possible relevance to transactions that the system will memorialize. As with the real-time embodiment, the selection criteria may be defined by the client, the auditor, or jointly. Additionally, it is preferred that the filtering and importing module include one or more graphical user interfaces for defining the selection criteria such that it can be viewed and changed or updated relatively easily.

As with the first embodiment, because the attachments may not be in a form easily searchable (e.g., .jpg, .tiff., .pdf, etc.) the attachments may be subjected to an Optical Character Recognition (OCR) process to identify words, phrases and other content that may be searched using the selection criteria. Once the emails and attachments are identified, they are imported (block 250) into a memory location such as a database accessible via a LAN or WAN (e.g., Internet) server. According to one aspect of the present invention, the filtering and importing module 239 comprises, or accesses the ImDex™ software program, owned by the assignee of the present invention, as described above. Alternatively, a similar program having importation features may be used.

Referring again to FIG. 4, pertinent paper correspondence may also be identified (block 255), scanned (block 260), and transferred to the data center 204 via a secure communication for processing (block 265). Like the emails and attachments, the scanned correspondence is then compared against the selection criteria, indexed, based preferably by vendor name, and stored in an enterprise server (block 270). It will be appreciated that although the steps identified by blocks 255-270 are illustrated as being performed subsequent to the steps identified by blocks 240-250, the steps of blocks 255-270 may also be performed or executed simultaneously with the steps identified by blocks 240-250.

It will therefore be appreciated that the latter embodiment discussed with respect to FIGS. 3 and 4 is similar to the embodiment discussed with respect to FIGS. 1 and 2. The primary difference is that the filtering of emails and attachments occurs, in the second embodiment, at the data center rather than the company email server, as in the first embodiment. However, it will be appreciated that both embodiments described above may be implemented by computer program products located on the company email server and at the data center. For instance, both the company email server and at the data center may include modules that apply selection criteria to filter email, attachments and scanned correspondence. Therefore, the same software and/or computer program products residing at the company email server and data center may be used to implement both of the embodiments described above. Likewise, because the data center and company email server are combinable, the modules described in each of the embodiments above may be combined into a single software package that implements each of the features described herein.

Many modifications and other embodiments of the inventions set forth herein will come to mind to one skilled in the art to which these inventions pertain having the benefit of the teachings presented in the foregoing descriptions and the associated attachments. Therefore, it is to be understood that the inventions are not to be limited to the specific embodiments disclosed and that modifications and other embodiments are intended to be included within the scope of the present disclosure. Although specific terms are employed herein and in Exhibit A, they are used in a generic and descriptive sense only and not for purposes of limitation.

That which is claimed:

1. A system for filtering and storing electronic communications, comprising:
an email server, wherein the email server is operable to receive at least one email addressed to a recipient;
a data center, in communication with the email server, for storing email; and
an email filtering module, wherein the email filtering module is operable to apply selection criteria to the at least one email, and to transmit a copy of the at least one email to the data center for storage when the at least one email matches the selection criteria.

2. The system of claim 1, wherein the email server comprises the email filtering module.

3. The system of claim 1, wherein the email server is local to the data center.

4. The system of claim 1, wherein the data center further comprises an indexing module for indexing the copy of the at least one email transmitted to the data center based at least in part on the contents of the copy of the at least one email.

5. The system of claim 4, wherein the data center further comprises an enterprise server for retrieving the indexed copy of the at least one email transmitted to the data center.

6. The system of claim 1, wherein the data center further comprises an indexing module for viewing the copy of the at least one email transmitted to the data center.

7. The system of claim 1, wherein the data center further comprises an indexing module for searching the copy of the at least one email transmitted to the data center, wherein the indexing module searches the copy of the at least one email based on at least one user-defined search term.

8. The system of claim 1, wherein the email filtering module is operable to apply selection criteria to the at least one email by comparing the selection criteria to the contents of the at least one email.

9. The system of claim 1, wherein the at least one email further comprises an attachment.

10. The system of claim 9, further comprising optical character recognition means, wherein the optical character recognition means performs optical character recognition on the attachment prior to the email filtering module applying selection criteria to the at least one email.

11. The system of claim 9, wherein the email filtering module is operable to apply selection criteria to the at least one email in real-time such that the selection criteria is applied to the at least one email immediately upon receipt of the at least one email by the email server.

12. The system of claim 1 1, wherein the email filtering module comprises a plug-in operating with the email server.

13. The system of claim 1, further comprising a scanning means for scanning paper documents not in electronic form, such that the scanned paper documents may be stored in electronic form in said data center.

14. A method for capturing and archiving email, comprising:
receiving selection criteria, the selection criteria for use in filtering at least one email based on one or more selection criteria terms;
filtering the at least one email using the selection criteria by determining whether the selection criteria terms match contents of the at least one email; and
storing the at least one email where the at least one email contents match the selection criteria.

15. The method of claim 14, further comprising indexing the at least one email based on a vendor identification contained in the at least one email.

16. The method of claim 14, wherein the at least one email further comprises at least one attachment associated therewith.

17. The method of claim 16, further comprising the step of performing optical character recognition on the at least one attachment prior to filtering the at least one email using the selection criteria.

18. The method of claim 17, wherein the filtered at least one email and the filtered at least one attachment are retrievable from storage according to a vendor identification contained in the filtered at least one email or in the filtered at least one email attachment.

19. A system for filtering and storing electronic communications, comprising:
an email server, wherein the email server is operable to receive at least one email addressed to a recipient;
a data center, in communication with the email server, for storing email; and
an filtering module, wherein the filtering module is operable to apply selection criteria to the at least one email, and to store a copy of the at least one email in the data center when the at least one email matches the selection criteria.

20. The system of claim 19, wherein the data center comprises the filtering module.

21. The system of claim 19, wherein the email server further comprises an archiving module, in communication with the email server, wherein the archiving module is operable to save the at least one email in archive format.

22. The system of claim 19, wherein the filtering module is further operable to index the stored copy of the at least one email matching the selection criteria, wherein the filtering module indexes the stored copy based at least in part on the contents of the at least one email.

23. The system of claim 19, wherein the filtering module is further operable to view the copy of the at least one email stored in the data center.

24. The system of claim 19, wherein the filtering module is further operable to permit a user to search the copy of the at least one email stored in the data center, wherein the filtering module permits a user to search the copy of the at least one email based on at least one user-defined search term.

25. The system of claim 19, wherein the filtering module is operable to apply selection criteria to the at least one email by comparing the selection criteria to the contents of the at least one email.

26. The system of claim 19, wherein the at least one email further comprises an attachment.

27. The system of claim 19, further comprising optical character recognition means, wherein the optical character recognition means is in communication with the data center and is operable to perform optical character recognition on the attachment.
